(19) United States
(12) Patent Application Publication
(10) Pub. No.: US 2019/0367067 A1
(43) Pub. Date: Dec. 5, 2019

(54) DEVICE FOR MANUALLY RAISING OR LOWERING A LOAD TO ASSIST OVERCOMING OBSTACLES, AND LOAD INCLUDING A DEVICE OF THAT KIND

(71) Applicants: Arturo Mazzolini, Auray (FR); Sylvie Desriac Épouse-Mazzolini, Auray (FR); Camille Mazzolini, Auray (FR); Justine Mazzolini, Hérouville-Saint-Clair (FR); Lisa Mazzolini, Rennes (FR)

(72) Inventors: Arturo Mazzolini, Auray (FR); Sylvie Desriac Épouse-Mazzolini, Auray (FR); Camille Mazzolini, Auray (FR); Justine Mazzolini, Hérouville-Saint-Clair (FR); Lisa Mazzolini, Rennes (FR)

(21) Appl. No.: 16/425,679

(22) Filed: May 29, 2019

(30) Foreign Application Priority Data
May 29, 2018 (FR) 1854556

(51) Int. Cl. B62B 5/02; A45C 5/03; A45C 5/14; A45C 13/26

(52) U.S. Cl. CPC B62B 5/028; A45C 5/03; A45C 2005/147; A45C 13/262; A45C 2013/267; A45C 5/146

(57) ABSTRACT

A device capable of manually raising or lowering a means for transporting a load to assist overcoming obstacles, including an arm automatically articulated about an articulation attached to the means for transporting the load between a first position retracted by the weight of the load and a second position deployed by the action of an elastic element, and a damping system capable of storing and releasing potential energy and of restoring it when the means for transporting the load is raised to overcome an obstacle and capable of absorbing shocks suffered by the transport means while overcoming a difference in level.

### BACKGROUND

It is commonplace to encounter difficulties when overcoming obstacles with a trolley or a suitcase when the weight becomes significant for the person handling it, notably when ascending or descending obstacles having large differences in level, such as for example curbs, thresholds, and in particular doors or staircase steps.

Suitcases generally comprise a telescopic handle and at least two wheels in order to facilitate movement of the suitcase. Thanks to the wheels, often of small size, small obstacles can be overcome with only the physical strength of the user to raise the entirety of the load.

However, in the case of overcoming a larger or repetitive obstacle, such as staircase steps, and with a load exceeding the physical capabilities of the user, the wheels become insufficient to facilitate ascent or descent and there is a risk of the moving load causing the person to lose their balance.

In fact, in the case of descending an obstacle, such as steps, the load, under its own weight, drops onto the immediately lower step (termed the downward step), which leads to damage to the wheels, or even to the load, unpleasant noise and even in some cases the person holding the load or the trolley losing their balance, which may lead to that person falling over or losing control of the object.

In the case of ascending an obstacle, such as a threshold or a step, if the weight of the load is greater than the physical capabilities of the user or their ability to avoid losing their balance, the user will be prevented from overcoming the difference in level or will risk losing their balance. Moreover, the load may rub against the obstacle, generating accelerated deterioration of the means for transporting said load.

There exist mechanisms including three wheels orbiting an axle. However, this kind of mechanism has limitations. In fact, although it facilitates overcoming small differences of level by ascending them, it does not facilitate descending them. Moreover, this kind of mechanism considerably increases the exterior overall size and is not compatible with the “cabin baggage” criteria established by airlines.

There therefore exists a need to improve the overcoming of obstacles by facilitating the manual raising and lowering of a load, in particular a suitcase, in order to be able to overcome the obstacle safely, minimizing the physical effort and meeting in all respects the “cabin baggage” criteria, and all this without deterioration of the means for transporting the load.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure concerns the field of assistance devices for manually raising or lowering a load, such as a trolley, a suitcase or any other similar means, in order to overcome a difference in level without losing balance and without damaging the means for transporting the load.

In fact, in an assistance device of this kind it is difficult to be able to overcome an obstacle without having to apply high forces and without damaging the transport means that carry the load.

The present disclosure more particularly concerns assistance devices of this kind integrated into a suitcase or more generally into a system for transporting a load.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a perspective view of a device for manually raising or lowering a load, in particular a suitcase, for example, to assist overcoming obstacles;

FIG. 2 shows a suitcase including the device from FIG. 1 for assisting overcoming obstacles;

FIGS. 3a to 3c show the steps of the suitcase from FIG. 2 overcoming a downward obstacle; and

FIGS. 4a to 4c show the steps of the suitcase from FIG. 2 overcoming an upward obstacle.

### DETAILED DESCRIPTION

The aim of the present disclosure is to provide a device capable of addressing in all respects the need disclosed in the Background section.

The present disclosure includes a device for assisting overcoming obstacles capable of manually raising or lowering a means for transporting a load, in particular a suitcase.

The assistance device includes at least one arm automatically articulated about an articulation attached to the means for transporting the load between a first position retracted by the weight of the load and a second position deployed by the action of an elastic damping element configured to be retracted by the effect of the weight of the load, able to damp shocks, to store potential energy and to return the arm automatically to the deployed second position when the load is at least partly raised by the user to overcome an obstacle.

The assistance device further includes a system configured to prevent rubbing and deterioration of the means for transporting the load against the obstacle to be overcome.

The assistance device therefore makes it possible to ascend and descend differences in level, even large ones, minimizing noise, shocks and rubbing induced by the effect of gravity on the means for transporting the load.

This kind of assistance device also makes it possible to relieve the user of the weight of the load when overcoming large obstacles, by minimizing any overbalancing effect that the load might have on the user.

The device advantageously includes at least one main wheel constrained to rotate with the arm on the side opposite the articulation.

The diameter of the main wheel is for example greater than the height of the arm.

The system configured to prevent the means for transporting the load rubbing against the obstacle to be overcome and sustaining damage advantageously includes at least one secondary wheel constrained to rotate with the free end of the arm or any other friction limiting means, such as crimped balls, for example.

The secondary wheels have a smaller diameter than the main wheel, for example.

According to one embodiment, the articulated arm includes two substantially parallel parts including a first end constrained by its articulation to rotate with the means for transporting the load and a free second end opposite the first end.

According to one embodiment, the articulated arm includes one or two parts including a first end constrained to rotate via its articulation with the load and a free second end opposite the first end.

The first end of each of the arm parts includes an articulation for rotation in a vertical plane, for example.

The main wheel is advantageously constrained to rotate with the arm between the two arm parts in the vicinity of the free second end, that is to say closer to the free second end than to the articulated first end.

For example, each of the two arm parts includes at its free end a secondary wheel or a crimped ball.

The secondary wheels have a smaller diameter than the main wheel, for example.

The damping system may be produced by means of an elastic element attached to the articulation or any other means capable of storing energy, such as a synthetic or natural elastomer, a torsion bar or a compressible gas, for example.

The damping system may include a shock absorbing end of travel element either incorporated in it or separate from it, such as an elastomer abutment or an abutment containing a compressible gas.

The damping system may be adjustable from the inside or the outside of the load in order to adjust it to suit the weight of said load, for example by means of graduations indexed on the load as a function of the weight to be lifted and a minimum force necessary to activate the assistance device.

The assistance device includes a mechanism for locking the arm in the retracted first position in order to render the assistance device inactive to minimize the overall size and so that it continues to be compatible with cabin baggage criteria. This function is necessary in order to conform to the “cabin baggage” criteria.

According to a second aspect, the disclosure is applied to a suitcase including a handle, for example a telescopic handle, terminating in a handgrip, at least two wheels situated on the same side as the handle and a device for assisting overcoming obstacles as described above disposed laterally between the two wheels and completely integrated into the lower part of the suitcase in the retracted first position.

Thanks to the integration of the assistance device inside the load and the retracted position of the locking device, the exterior overall size of the load is not increased and this makes it possible to comply with airline standards for cabin suitcases whilst minimizing the volume reserved for the assistance device relative to the total interior volume of the means for transporting the load.

For example, the suitcase includes a rear wheel on the side opposite the handle. Alternatively, the suitcase could include two front wheels and two rear wheels. The suitcase could equally not include rear wheels, or again not include any wheels, but rather positioning studs making it possible for the suitcase not to rest with its lower part directly on the ground.

The articulation of the device for assisting overcoming obstacles is disposed in a nonlimiting manner on the side opposite the handle or in any other direction that would facilitate production or operation.

It will be noted that the disclosure is not limited to integrating the device for assisting overcoming obstacles into a suitcase. It extends to any manual means for transporting a load.

In a third aspect, the disclosure concerns a goods handling frame including a handgrip, for example a telescopic handgrip, at least two wheels situated on the same side as the handgrip and a device for assisting overcoming obstacles as described above disposed laterally between the two wheels.

The action of overcoming a downward obstacle, such as a staircase step for example, is performed as follows.

When descending an obstacle, the arm of the device for assisting overcoming obstacles is automatically actuated around the articulation into the deployed position as soon as the wheel of the device is caused to leave the first step by the action of the elastic element. The main wheel of the assistance device therefore comes into contact with the lower step and the integrated damping system is in turn activated to enable damping of the descent, before the fixed wheels of the means for transporting the load come into contact with the lower step.

When the means for transporting the load finds itself in contact with the lower step, the arm of the device for assisting overcoming obstacles is automatically actuated around the articulation into the retracted position, again by the effect of the weight of the load.

The action of overcoming an upward obstacle, such as a staircase step for example, is performed as follows.

In order to ascend an obstacle, the user raises the load, by just what is necessary for the assistance device to begin to be actuated, and therefore moves the wheels closer to the level of the upper step. This function may be adjustable, the effect of which is to maintain the arm constantly in contact with the step and therefore to continue to compensate the residual weight of the load supported by the mechanism. The arm of the device for assisting overcoming obstacles is therefore automatically actuated around the articulation into a second position in which it is deployed to a greater or lesser degree as a function of the load and of the adjustment chosen by the user. The main wheel of the assistance device in contact with the lower step comes to bear on the rim or nose of the upper step with no rubbing, thanks to the secondary wheels or to the crimped balls, so as to roll on the latter in the upward direction on the nose of the step, preventing rubbing on the load before arriving on the upper step.

When the load finds itself on the upper step, the arm of the device for assisting overcoming obstacles is again actuated around the articulation and again finds itself in the first position retracted to a greater or lesser degree by the effect of the weight of the load and of the adjustment chosen.

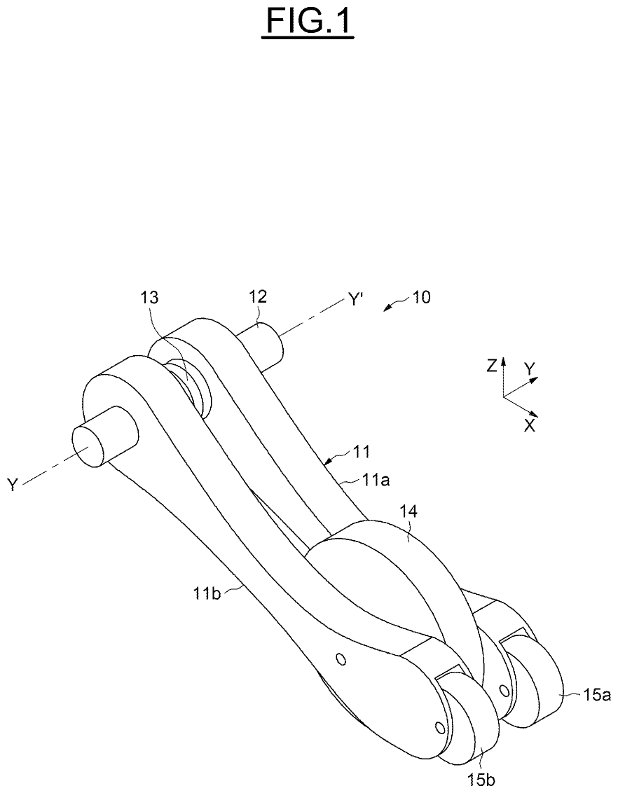

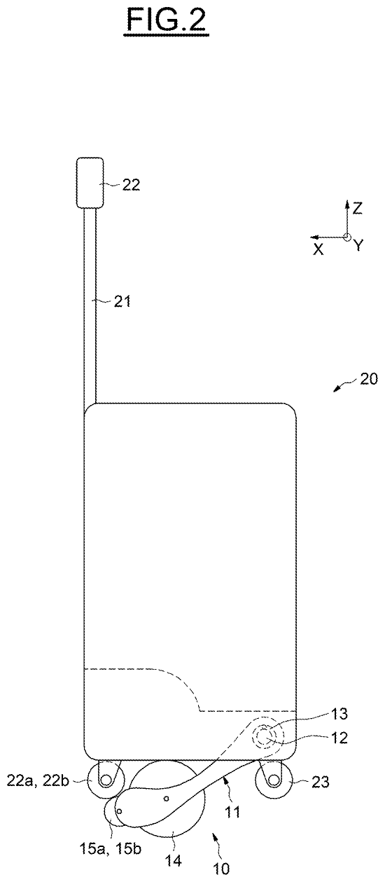

As shown in FIG. 1, a device 10 for assisting overcoming obstacles enables manual raising or lowering of a means for transporting a load 20, in particular a suitcase that can be seen in FIG. 2.

The device 10 for assisting overcoming obstacles includes an arm 11 articulated around an articulation 12 attached to the means for transporting the load 20. The articulated arm 11 includes two substantially parallel parts 11a, 11b having a first end constrained to rotate with the means for transporting the load 20 and a free second end opposite the first end.

The first end of each of the arm parts 11a, 11b includes a housing (no reference number) receiving the articulation 12. The arm 11 of the device 10 for assisting overcoming obstacles is therefore articulated between a position retracted by the weight of the load and a deployed, so-called rest position considering intermediate positions resulting from the weight to be lifted and of the adjustment effected by the user.

The device 10 for assisting overcoming obstacles further includes a damping system 13 capable of storing energy, such as for example a spring, a natural or synthetic elastomer, torsion of a mechanical element or a cavity containing a compressible gas attached to the articulation 12 and possibly an end of travel abutment for damping shocks caused by overcoming downward differences of level.

Thanks to the damping system 13, the arm 11 returns automatically into its deployed or rest position by the action of the reduced load on the elastic element when the load 20 is lifted to overcome an obstacle.

The damping system 13 may be adjustable from the inside or the outside of the load in order to adjust it to suit the weight of said load, for example with the aid of graduations.

The device 10 may be rendered inactive to minimize the overall size thanks to a key, a wedge or any other rotation blocking system actuated from the inside or the outside of the transport means.

The device 10 for assisting overcoming obstacles includes a main wheel 14 constrained to rotate between the two parts 11a, 11b of the arm 11 in the vicinity of the free second end, that is to say closer to the free second end than the articulated first end.

The diameter of the main wheel 14 is greater than the height of the arm 11 so that it is always the wheel that first comes into contact with the ground, not the arm.

Each of the two arm parts 11a, 11b may include at its free end a secondary wheel 15a, 15b or crimped balls. The secondary wheels 15a, 15b or the crimped balls form a system for preventing rubbing of the load against the difference of level to be overcome and damage thereto. If the need makes itself felt, the secondary wheels or the crimped balls will advantageously be fixed to the transport means itself.

The secondary wheels 15a, 15b have a smaller diameter than the main wheel 14 in order not to interfere with its action.

Alternatively, the device 10 for assisting overcoming obstacles could not include any wheels and rest directly on its free end in the deployed position.

In the nonlimiting example shown in FIG. 2 the device 10 from FIG. 1 for assisting overcoming obstacles is integrated directly into a means for transporting a load such as a suitcase 20, in particular into its lower part.

The suitcase 20 includes a handle 21, which is telescopic for example, ending in a handgrip 22. The suitcase 20 also includes two front wheels 22a, 22b situated on the same side as the handle 21 and at least one rear wheel 23 on the side opposite the handle 21. Alternatively, the suitcase could include two front wheels and two rear wheels. The suitcase could also not include rear wheels, or any wheels, but rather positioning studs making it possible to prevent the lower part of the suitcase from resting directly on the ground thanks to permanent action of the device for assisting overcoming obstacles.

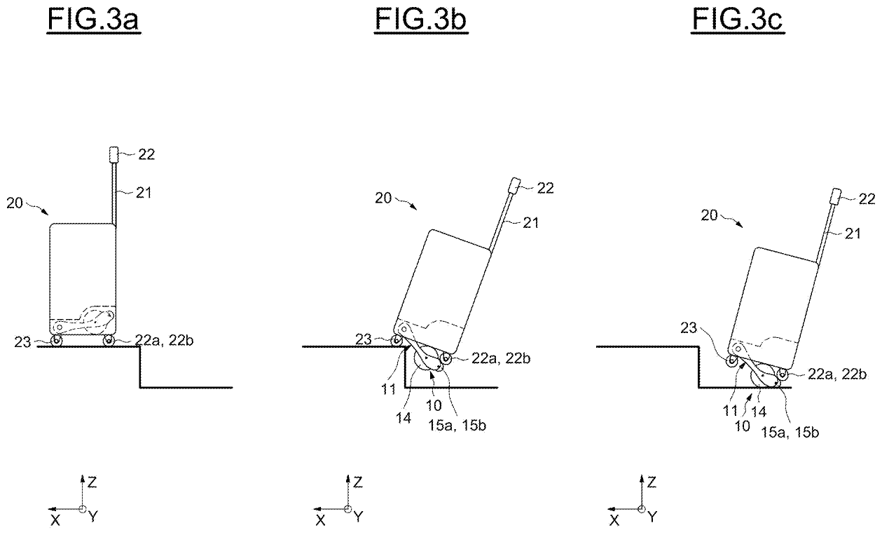

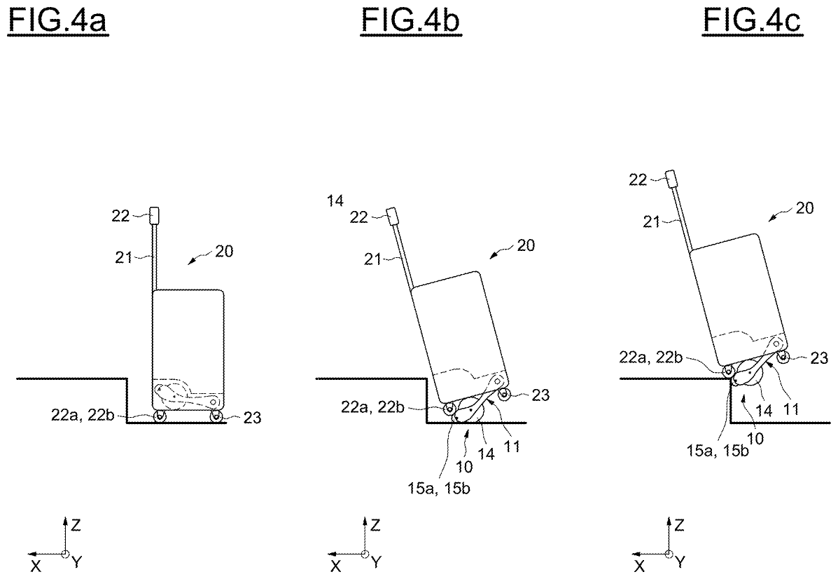

The device 10 for assisting overcoming obstacles is disposed laterally between the two front wheels 22a, 22b and integrated completely into the lower part of the suitcase 20 in the retracted position, visible in FIGS. 3a and 4a.

The articulation 12 of the device 10 for assisting overcoming obstacles is disposed on the side opposite the handle 21, here on the same side as the rear wheel or wheels 23.

It will be noted that the disclosure is not limited to the integration of the device 10 for assisting overcoming obstacles into the suitcase or other means for transporting loads. Alternatively, a frame for handling goods could be provided including at least two wheels and a handgrip, for example a telescopic handgrip. The assistance device 10 is in this case integrated into the handling frame between the two wheels situated on the same side as the handle.

A mechanism could also be provided for locking the device 10 for assisting overcoming obstacles in its retracted position thanks to indexing means such as for example a pawl that can be retracted manually by the user and is accessible from the inside or the outside of the transport means.

The action of overcoming a downward obstacle, such as a staircase step for example, is performed as follows, referring to FIGS. 3a to 3c.

When descending an obstacle, the arm 11 of the device 10 for assisting overcoming obstacles is automatically articulated around the articulation 12 into the deployed position, visible in FIGS. 3b and 3c. The main wheel 14 of the device 10 comes into contact with the lower step and the spring 13 enables damping of its descent before contact of the fixed front wheels 22a, 22b of the suitcase 20 with the lower step.

When the suitcase 20 finds itself on the lower step, the arm 11 of the device 10 for assisting overcoming obstacles is articulated around the articulation 12 to be returned into the retracted position, visible in FIG. 3a, by the effect of the weight of the suitcase.

The action of overcoming an upward obstacle, such as a staircase step for example, is performed as follows, referring to FIGS. 4a to 4c.

In order to ascend an obstacle, the user lifts the suitcase 20 “to the minimum”, the effect of which is to return the arm 11 automatically to its deployed or rest position because of a lower real load and therefore advantageously to move the transport means closer to the upward difference in level. The arm 11 of the device 10 for assisting overcoming obstacles is therefore automatically actuated around the articulation 12 into the deployed position, visible in FIGS. 4b and 4c. The main wheel 14 of the device 10 comes into contact with the lower step (FIG. 4b) and then, by means of its secondary wheels 15a and/or 15b or the crimped balls, with the nose of the upper step (FIG. 4c), before arriving on the upper step.

When the suitcase 20 finds itself on the upper step, the arm 11 of the device 10 for assisting overcoming obstacles is articulated around the articulation 12 and returns into the retracted position, visible in FIG. 4a, by the effect of the weight of the suitcase.

The device 10 could also include a system (not shown) for deactivating the device. The deactivation device includes, for example, a pawl, a key or any other system for blocking rotation of the articulation that can be activated from the inside or the outside of the transport means.

Thanks to the disclosed embodiments, it is possible to ascend and to descend differences in level, even large differences, minimizing damage to the wheels and the suitcase, whilst relieving the user of the weight of the suitcase and minimizing their loss of balance.

Moreover, thanks to the integration of the device into the inside of the suitcase and the system for deactivating the assistance device, the exterior overall size of the suitcase is not increased and enables compliance with airline standards concerning suitcases accepted in the cabin.

It will be noted that the disclosed embodiments are not limited to a trolley or a suitcase, but may be applied to any other like means, such as a two-wheel hand truck for example. In the case of a two-wheel hand truck, the device for assisting overcoming obstacles will function in the opposite manner to the functioning of a suitcase in that to descend a difference in level the user pushes the two-wheel hand truck instead of pulling it.

While illustrative embodiments have been illustrated and described, it will be appreciated that various changes can be made therein without departing from the spirit and scope of the invention.

The embodiments of the invention in which an exclusive property or privilege is claimed are defined as follows:

1. A device capable of manually raising or lowering a means for transporting a load to assist overcoming obstacles, characterized in that it includes:
at least one arm automatically articulated about an articulation attached to the means for transporting the load between a first position retracted by the weight of the load in which said device is integrated into a lower part of the means for transporting the load and a second position deployed by the action of an elastic element,
at least one main wheel constrained to rotate with the arm on the side opposite the articulation,
a damping system capable of storing energy, damping shocks and automatically returning the arm into the deployed second position when the means for transporting the load is at least in part raised by the user to overcome an obstacle, and
a system configured to prevent rubbing the means for transporting the load against the obstacle to be overcome and damage thereto, said system including at least one secondary wheel or a crimped ball constrained to rotate with the free end of the arm on the side opposite the articulation.

2. The device according to claim 1, in which the articulated arm includes one or two parts including a first end constrained to rotate via its articulation with the load and a free second end opposite the first end.

3. The device according to claim 2, in which the main wheel is constrained to rotate with the arm between the two arm parts in the vicinity of the free second end.

4. The device according to claim 2, in which each of the two arm parts includes at its free end a secondary wheel or crimped ball.

5. The device according to claim 1, in which the damping system is a spring, a natural or synthetic elastomer, a mechanical torsion element or a cavity containing a compressible gas attached to the articulation.

6. The device according to claim 1, in which the damping system is adjustable from the inside or the outside of the means for transporting the load.

7. A suitcase including a handle terminating in a handgrip, at least two wheels situated on the same side as the handle and a device for assisting overcoming obstacles according to claim 1 disposed laterally between the two wheels and completely integrated into the lower part of the suitcase in the retracted first position.

8. A goods-handling frame including a handgrip, at least two wheels situated on the same side as the handgrip and a device for assisting overcoming obstacles according to claim 1 disposed laterally between the two wheels.
